(19) United States
(12) Patent Application Publication
(10) Pub. No.: US 2010/0185986 A1
(43) Pub. Date: Jul. 22, 2010

(54) System and Method for Displaying Data File Properties in an Information Handling System

(75) Inventors: Carrie Quintanilla, Cedar Park, TX (US); Charles G. Morton, III, Leander, TX (US)

Correspondence Address: Baker Botts L.L.P, 910 Louisiana Street, One Shell Plaza, HOUSTON, TX, 77002, US

(73) Assignee: DELL PRODUCTS L.P., Round Rock, TX (US)

(21) Appl. No.: 12/355,084

(22) Filed: Jan. 16, 2009

(51) Int. Cl. G06F 3/048

(52) U.S. Cl. 715/835

(57) ABSTRACT

Systems and methods for displaying data file properties within a user interface system are disclosed. An information handling system may include a display device and a user interface system. The user interface system may be configured to access data defining a plurality of different data file properties; establish a collection of data files, where each data file corresponds to one of the data file properties; associate a data file icon with each data file in the collection; and establish a plurality of different icon visual effects, where each different icon visual effect corresponds to one of the data file properties. The user interface system may be further configured to apply the icon visual effect to the data file icon associated with each data file in the collection, and to display a representation of the collection, including displaying the visually effected data file icon for each data file in the collection.

### TECHNICAL FIELD

The present disclosure relates generally to displaying data file properties in an information handling system, and more particularly to representing different data file properties by applying different visual effects to data file icons.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Increasingly, information handling systems are deployed with graphical user interface systems by which a user interacts with the data files and software applications stored on the information handling system. Some of these user interface systems provide a graphical menu, sometimes referred to as a “dock,” that presents the user with icons representing data files and software applications. Often, these user interface systems are employed for numerous reasons, including without limitation: (1) improving the accessibility of frequently used data files and software applications and (2) enhanced productivity through user configuration of the user interface system.

### SUMMARY

In accordance with one embodiment of the present disclosure, an information handling system may include a display device and a user interface system displayed on the display device. The user interface system may be configured to access data defining a plurality of different data file properties; establish a collection of data files, where each data file corresponds to one of the data file properties; associate a data file icon with each data file in the collection; and establish a plurality of different icon visual effects, where each different icon visual effect corresponds to one of the data file properties. For each data file in the collection, the user interface system may be further configured to apply one of the icon visual effects to the data file icon associated with that data file such that the applied icon visual effect represents the data file property corresponding to that data file. The user interface system may also be configured to display a representation of the collection, including displaying the visually effected data file icon for each data file in the collection.

In accordance with another embodiment of the present disclosure, a method is provided for displaying data file properties in an information handling system that includes a display device and a user interface system. The method may be performed by a user interface system and may include accessing data defining a plurality of different data file properties; establishing a collection of data files, where each data file corresponds to one of the data file properties; associating a data file icon with each data file in the collection; and establishing a plurality of different icon visual effects, where each different icon visual effect corresponds to one of the data file properties. The method may further include applying, for each data file in the collection, one of the icon visual effects to the data file icon associated with that data file such that the applied icon visual effect represents the data file property corresponding to that data file. The method may further include displaying a representation of the collection, including displaying the visually effected data file icon for each data file in the collection.

In accordance with a further embodiment of the present disclosure, a user interface system may be configured to access data defining a plurality of different data file properties; establish a collection of data files, where each data file corresponds to one of the data file properties; associate a data file icon with each data file in the collection; and establish a plurality of different icon visual effects, where each different icon visual effect corresponds to one of the data file properties. For each data file in the collection, the user interface system may be further configured to apply one of the icon visual effects to the data file icon associated with that data file such that the applied icon visual effect represents the data file property corresponding to that data file. The user interface system may also be configured to display a representation of the collection, including displaying the visually effected data file icon for each data file in the collection.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for displaying data file properties in an information handling system, in accordance with certain embodiments of the present disclosure;

FIG. 2 illustrates a graphical representation of certain embodiments of a user interface system displayed on a display device, in accordance with the present disclosure;

FIG. 3 illustrates a graphical representation of certain embodiments of a user interface system displayed on a display device, in accordance with the present disclosure;

FIG. 4 illustrates a graphical representation of certain embodiments of a user interface system displayed on a display device, in accordance with the present disclosure;

FIG. 5 illustrates a graphical representation of certain embodiments of a user interface system displayed on a display device, in accordance with the present disclosure;

FIG. 6 illustrates a graphical representation of certain embodiments of a user interface system displayed on a display device, in accordance with the present disclosure;

FIG. 7 illustrates a graphical representation of certain embodiments of a user interface system displayed on a display device, in accordance with the present disclosure; and

FIG. 8 illustrates a flow chart of an example method for displaying data files in an information handling system including a display device and a user interface system, in accordance with the present disclosure.

### DETAILED DESCRIPTION

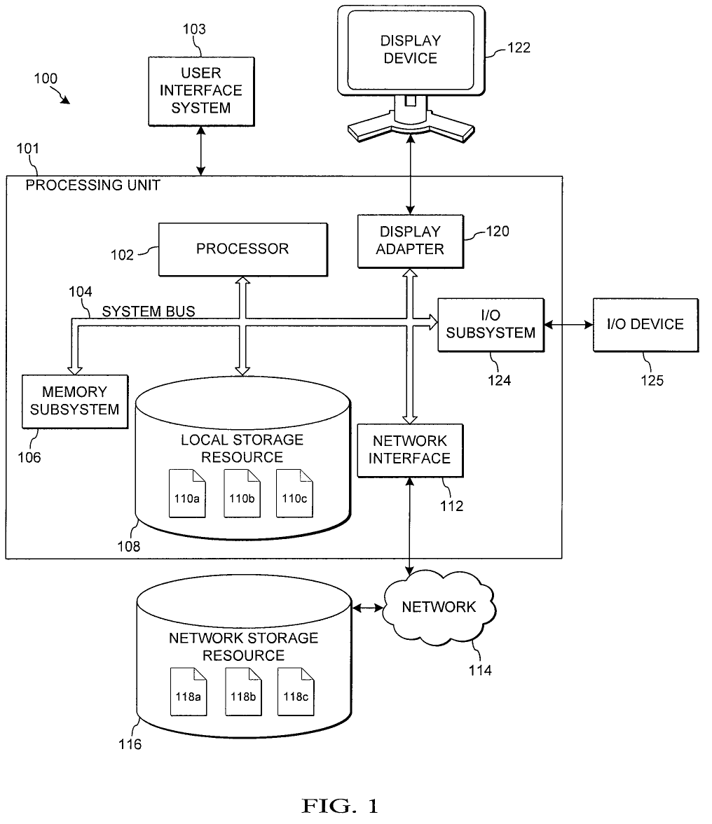

Preferred embodiments and their advantages are best understood by reference to FIGS. 1-8 wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such wires, optical fibers, microwaves, radio waves, and other electromagnetic and/or optical carriers; and/or any combination of the foregoing.

FIG. 1 illustrates a block diagram of an example system 100 for displaying data file properties in an information handling system, in accordance with the present disclosure. As depicted in FIG. 1, system 100 may comprise a processing unit 101, a user interface system 103, a network 114, a network storage resource 116, a display device 122, and an I/O device 125.

Components of processing unit 101 may include, but are not limited to, a processor 102 and a system bus 104 that communicatively couples various system components to processor 102 including, for example, a memory subsystem 106, a local storage resource 108, a network interface 112, a display adapter 120, and an I/O subsystem 124. System bus 104 may be any suitable type of bus structure, e.g., a memory bus, a peripheral bus, or a local bus using any of a variety of bus architectures. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

Processor 102 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 102 may interpret and/or execute program instructions and/or process data stored locally (e.g., in memory subsystem 106 and/or another component of processing unit 101). In the same or alternative embodiments, processor 102 may interpret and/or execute program instructions and/or process data stored remotely (e.g., in network storage resource 116).

User interface system 103 may comprise software generally operable to allow users to interact with information handling system 100. For example, user interface system 103 may provide images and/or text for display on display device 122. In the same or alternative embodiments, user interface system 103 may allow a user to manipulate the state of information handling system, for example, through the use of I/O device 125. In the same or alternative embodiments, user interface system 103 may allow the information handling system to produce the effects of a user's manipulation of the information handling system, for example by providing different or additional images and/or text for display on display device 122.

Memory subsystem 106 may comprise any system, device, or apparatus operable to retain program instructions or data for a period of time (e.g., computer-readable media). Memory subsystem 106 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 100 is turned off.

Local storage resource 108 may comprise computer-readable media (e.g., hard disk drive, floppy disk drive, CD-ROM, and/or other type of rotating storage media, flash memory, EEPROM, and/or other type of solid state storage media) and may be generally operable to store data. In some embodiments, data files 110a-c may be stored on local storage resource 108. Although FIG. 1 depicts three data files (110a-c) stored on local storage resource 108, any number of data files may be stored on local storage resource 108.

Network interface 112 may be any suitable system, apparatus, or device operable to serve as an interface between information handling system 100 and a network 114. Network interface 112 may enable information handling system 100 to communicate over network 114 using any suitable transmission protocol and/or standard, including without limitation all transmission protocols and/or standards enumerated below with respect to the discussion of network 114.

In some embodiments, network interface 112 may be communicatively coupled via network 114 to network storage resource 116. Network 114 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 114 may transmit data using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 114 and its various components may be implemented using hardware, software, or any combination thereof.

Network storage resource 116 may comprise computer-readable media (e.g., hard disk drive, floppy disk drive, CD-ROM, and/or other type of rotating storage media, flash memory, EEPROM, and/or other type of solid state storage media) and may be generally operable to store data. In some embodiments, data files 118a-c may be stored on network storage resource 116. Although FIG. 1 depicts three data files (118a-c) stored on network storage resource 116, any number of data files may be stored on network storage resource 116.

Data files 110a-c and 118a-c may comprise data in any format including ASCII, binary, or other formats. Further, data files 110a-c and 118a-c may be executable data files (e.g., an application), non-executable data files, folders (i.e., directories) as part of a file system running on information handling system 100, or any combination thereof. Data files 110a-c and 118a-c may have one or more data file properties, for example, a date on which the data file was last modified, a name corresponding to a user who created the data file, a due date associated with the data file, a version number corresponding to a particular version of the data file, or any property or combination of properties.

A data file “version,” as such term is used herein, may refer to a unique state of a data file to which a unique identifier has been assigned, as may be used to keep track of incrementally different versions of electronic information. For example, unique version names (e.g., “Draft File,” “Final File,” etc.), unique version numbers (e.g., 1, 2, 3; or 1.0, 1.1, 1.2; etc.), or any other unique identifier or combination thereof may be assigned to the unique states of a data file. In some embodiments, the assignment of unique identifiers to unique states of data files may be performed by a software application (e.g., document management software). In the same or alternative embodiments, the assignment of unique identifiers to unique states of data files may be performed by a user (e.g., saving copies of files with different names and/or different modification times).

The one or more data file properties associated with any of data files 110a-c and 118a-c may be embedded within the data file itself; stored and/or managed by a software application (e.g., a document management application may store version numbers corresponding to a particular data file); stored and/or managed by the user interface system 103; stored and/or managed by a file system running on information handling system 100; stored in a separate data file (e.g., a metadata file) located on network storage resource 116 or local storage resource 108; or any combination thereof.

Display adapter 120 may include any system, apparatus, or device suitable for generating and outputting images to a display. In some embodiments, display adapter 120 may also be suitable for processing input received from a display (e.g., a touch screen display). Display adapter 120 may output images to display device 122 using any display protocol, including without limitation Digital Visual Interface (DVI), Video Graphics Array (VGA), High-Definition Multimedia Interface (HDMI), Separated Video (S-Video), component video, and composite video. Although depicted as a component integrated into processing unit 101, display adapter 120 may be external to processing unit 101 (e.g., as a dedicated expansion card, as an external hardware unit directly connected to processing unit 101 or connected via a network (not shown), or as a component of display device 122).

Display device 122 may include any system, apparatus, or device suitable for creating graphic images and/or alphanumeric characters recognizable to a user, and may include, for example, a liquid crystal display (LCD), cathode ray tube (CRT), a plasma screen, and a digital light processor (DLP) projection monitor. In certain embodiments, display device 122 may include a computer monitor. In other embodiments, display device 122 may include a television. In still other embodiments, display device 122 may include a touch screen whereby a user may provide input to processing unit 101 by touching the screen of display device 122.

I/O subsystem 124 may comprise any system, device, or apparatus generally operable to receive and/or transmit data to/from/within information handling system 100. I/O subsystem 124 may comprise, for example, any number of communication interfaces, graphics interfaces, video interfaces, user input interfaces, and/or peripheral interfaces. In some embodiments, I/O subsystem 124 may be communicatively coupled to I/O device 125.

I/O device 125 may comprise any system, device, or apparatus generally operable to facilitate user interaction with information handling system 100. I/O device may comprise, for example, a computer keyboard, a mouse, a trackball, a microphone, and/or a graphics tablet. Any number of I/O devices 125 may be connected to I/O subsystem 124.

In operation, information handling system 100 may allow a user to interact with (e.g., view, modify, etc.) any of data files 110a-c stored on local storage resource 108 and/or data files 118a-c stored on network storage resource 116. For example, processor 102 may execute program instructions corresponding to user interface system 103. User interface system 103 may access data file properties associated with any of data files 110a-c and/or 118a-c. In this example, processor 102 (executing program instructions for user interface system 103) may communicate with display adapter 120 which may, in turn, output images to display device 122. In some embodiments, a user may provide input in response to the images on display device 122 by using I/O device 125.

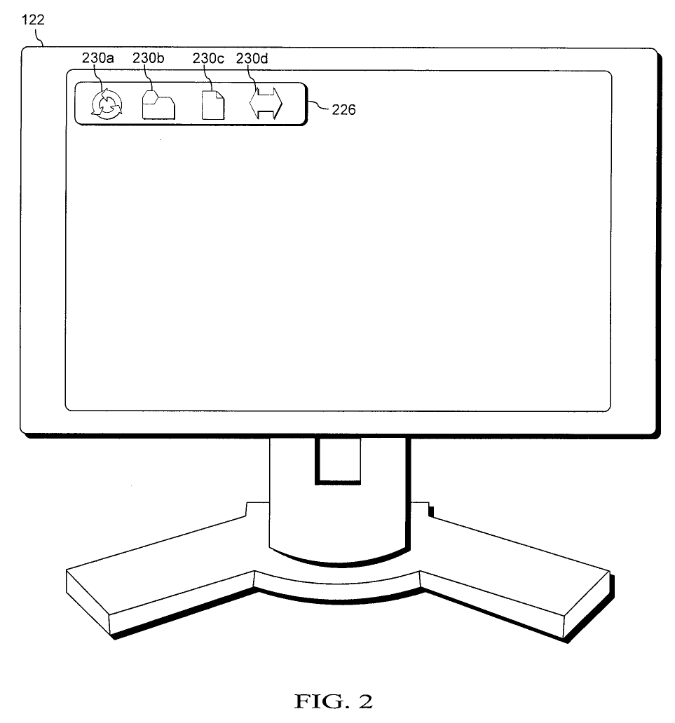

FIG. 2 illustrates a graphical representation of certain embodiments of user interface system 103 displayed on display device 122, in accordance with the present disclosure. As shown in FIG. 2, user interface system 103 may display a menu 226 on display device 122. In the illustrated embodiment, menu 226 may include icons 230a-d, each of which may represent a collection of data files (i.e., one or more data files) stored on information handling system 100. Although FIG. 2 depicts four icons 230a-d, menu 226 may include any number of icons. In the same or alternative embodiments, menu 226 may display text instead of (or in addition to) icons, where the displayed text may represent a collection of data files stored on information handling system 100. Although menu 226 is displayed in the upper left-hand corner of display device 122, it may be displayed in any location on display device 122 (e.g., bottom center, lower right, etc.). In some embodiments, user interface system 103 may display multiple menus 226 at the same time (e.g., the multiple menus may include icons and/or text corresponding to the same or different collections of data files). In addition, the style of menu 226 depicted in FIG. 2 (i.e., a row of aligned icons surrounded by a rectangular border) is by way of example, wherein other embodiments may provide a different style for menu 226.

In the example embodiment illustrated in FIG. 2, icon 230a may represent a collection of data files corresponding to a single executable software application file stored in local storage resource 108 of information handling system 100, such that when icon 230a is selected, processor 102 may execute program instructions corresponding to the software application. Continuing with the example, icon 230b may represent a collection of data files corresponding to those data files in a particular folder stored on network storage resource 116 of information handling system 100, such that when icon 230b is selected, further data and/or information related to the corresponding folder and/or the data files contained therein may be displayed by user interface system 103. Further, icon 230c may represent a collection of data files corresponding to multiple versions of a data file stored on local storage resource 108 of information handling system 100, such that when icon 230c is selected, further data and/or information related to the corresponding data file and/or its versions may be displayed by user interface system 103. In addition, icon 230d may represent a collection of data files corresponding to a single data file stored on local storage resource 108 of information handling system 100, such that when icon 230d is selected, the corresponding data file is opened with an associated software application.

In operation, user interface system 103 displays menu 226 and icons 230a-d on display device 122. Each of icons 230a-d may be selected by a user, for example, through the use of I/O device 125. To “select” an icon or other representation (e.g., text), as such term is used herein, may refer to any number of actions taken by a user of information handling system 100. For example, selecting may refer to clicking on one of icons 230a-d using a pointing device (e.g., a mouse), touching display device 122 in the location where one of icons 230a-d is displayed (i.e., assuming display device 122 is a touchscreen display), speaking a command associated with one of icons 230a-d into a microphone, hovering over one of icons 230a-d for a specified period of time using a pointing device (e.g., a trackball), pressing a key associated with one of icons 230a-d on a keyboard, or any other method of interaction provided by I/O device 125 in conjunction with information handling system 100.

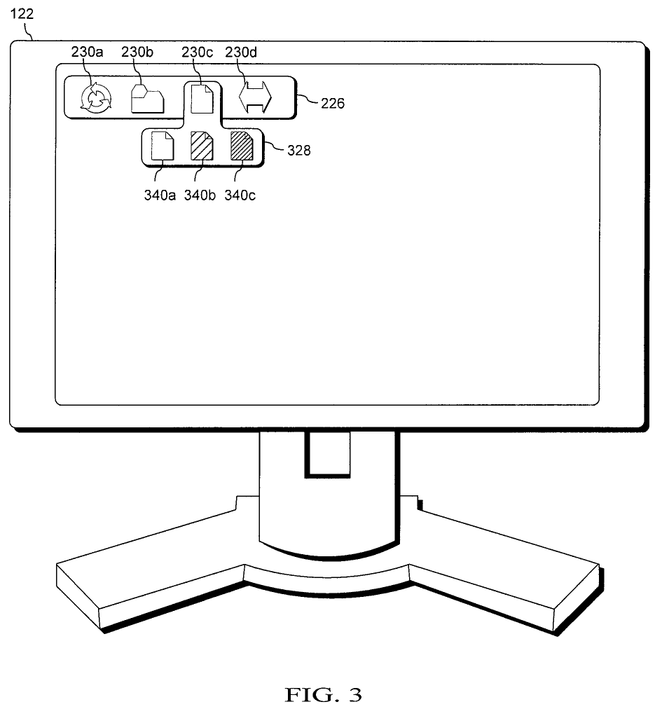

FIG. 3 illustrates a graphical representation of certain embodiments of user interface system 103 displayed on display device 122, in accordance with the present disclosure. In the illustrated embodiment, menu 226 may be the same menu depicted in FIG. 2. Also illustrated in FIG. 3 is a submenu 328 displayed upon selection of icon 230c. Submenu 328 may include data file icons 340a-c, each of which may represent a data file within the collection represented by icon 230c. Although FIG. 3 depicts three data file icons 340a-c, submenu 328 may include any number of data file icons. Although submenu 328 is displayed in close proximity to menu 226, it may be displayed in any location on display device 122, whether or not it is adjacent to menu 226. In addition, the style of submenu 328 depicted in FIG. 3 (i.e., a row of aligned data file icons surrounded by a rectangular border) is by way of example, wherein other embodiments may provide a different style for submenu 328. In some embodiments, submenu 328 may be the only menu displayed on display device 122 (i.e., menu 226 may be hidden and/or may not exist).

In some embodiments, icon 230c may represent a collection of data files established by user interface system 103 and corresponding to multiple versions of a data file stored on local storage resource 108 of information handling system 100. For example, icon 230c may represent a collection of data files corresponding to multiple versions of data file 110a (FIG. 1). According to this example, each of data file icons 340a-c may be associated with a different version of data file 110a. For example, data file icon 340c may be associated with version 1 of data file 110a, data file icon 340b may be associated with version 2 of data file 110a, and data file icon 340a may correspond to the most recent version, version 3, of data file 110a. Although each of data file icons 340a-c in FIG. 3 is depicted using the same data file icon (i.e., a graphic depiction of a piece of paper with a dog-eared top right corner), data file icons 340a-c may differ from each other in other embodiments.

As illustrated in FIG. 3, data file icons 340a-c have varying shades or patterns which represent a different icon visual effect that has been applied to each data file icon. In one embodiment, the applied icon visual effect may be a different transparency setting for each of data file icons 340a-c (e.g., 0% transparency for data file icon 340a, 20% transparency for data file icon 340b, 40% transparency for data file icon 340c). In the same or alternative embodiments, the applied icon visual effect may be a different color for each of data file icons 340a-c (e.g., red for data file icon 340a, orange for data file icon 340b, yellow for data file icon 340c). Where a differing color effect is used, it may be applied in any way to each of data file icons 340a-c, for example, to the background, the foreground (i.e., the pixels defining the icon shape), as a colored shadow, or any other possible application or combination thereof.

In operation, user interface system 103 may access data defining a plurality of different data file properties. Continuing with the example started above where each of data file icons 340a-c may be associated with a different version of data file 110a, user interface system 103 may access the version information for data file 110a (e.g., versions 1, 2, and 3). User interface system 103 may be configured to access the version information (i.e., the data file property) whether such property is embedded within the data file itself, stored and/or managed by a software application, or otherwise stored/and or managed. Thus, according to this example, user interface system 103 has established a collection of data files, each corresponding to a specific version of data file 110a.

Although the user interface system 103 in this example embodiment may establish a collection of data files that correspond to the different versions of a particular data file, user interface system 103 may, in the same or alternative embodiments, be configured to establish a collection of data files according to any logical relationship including, without limitation, all data files stored in a particular folder on information handling system 100, the most recently accessed data files, all data files associated with a particular software application, all versions of a particular data file, or any combination thereof. Thus, user interface system 103 may establish a collection of data files by accessing data files automatically and/or in response to user-provided configuration.

In addition, user interface system 103 may associate a data file icon with each data file in the established collection. Again, by way of the preceding example (where each of data file icons 340a-c may be associated with a different version of data file 110a) and as illustrated in FIG. 3, the associated data file icon is a graphic depiction of a piece of paper with a dog-eared top right corner. User interface system 103 may also establish a plurality of transparency settings to be applied to the different versions of data file 110a. As shown in FIG. 3, user interface system 103 may display submenu 328 on display device 122 in response to the selection of icon 230c located on menu 226. Thus, data file icons 340a-c in submenu 328 may represent the collection of data files corresponding to distinct versions of data file 110a. In addition and continuing the example, user interface system 103 may apply different transparency settings to each of data file icons 340a-c (illustrated by the differing shades/patterns). Application of the visual effect (e.g., transparency setting) may occur prior or subsequent to the user interface system 103 displaying data file icons 340a-c.

Thus, when the data file icons are displayed, a user may be able to distinguish between different data file properties based on the differing visual effects that may be applied to each data file icon in the displayed collection of data files. Continuing the previous example, a user viewing the embodiment depicted in FIG. 3 may be able to distinguish between the different versions of data file 110a simply by noticing the differing levels of transparency that have been applied by user interface system 103 to each of data file icons 340a-c.

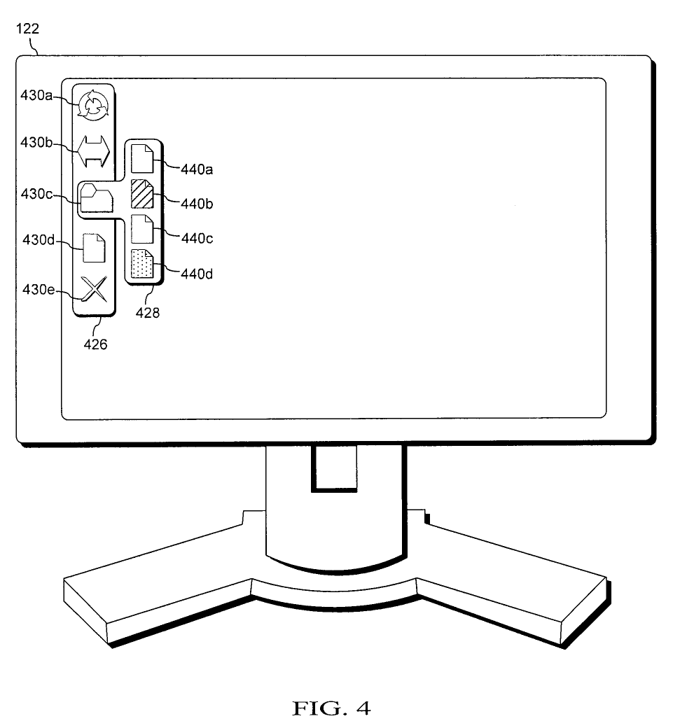

FIG. 4 illustrates a graphical representation of certain embodiments of user interface system 103 displayed on display device 122, in accordance with the present disclosure. In the illustrated embodiment, a menu 426 may be displayed on display device 122, and may include icons 430a-e. Icons 430a-e may each represent a collection of data files (i.e., one or more data files) stored on information handling system 100. As further shown in FIG. 4, submenu 428 may be displayed on display device 122, and may include data file icons 440a-d. In this embodiment, menu 426 and submenu 428 may be analogous and have similar properties as described with respect to menu 226 and submenu 328 in FIG. 3.

In operation, user interface system 103 may establish a collection of data files including data files 110a and 118a-c (FIG. 1). In the embodiment depicted in FIG. 4, each data file icon 440a-d may be associated with one of the data files in the established collection (110a and 118a-c). User interface system 103 may associate a data file icon with each data file in this established collection, and may access the data file property representing the name of the creator of each data file 110a/118a-c. User interface system 103 may also establish a plurality of colors to be applied to each of data files 110a/118a-c having a different creator. As shown in FIG. 4, user interface system 103 may display submenu 428 on display device 122 in response to the selection of icon 430c located on menu 426. In addition and continuing the example, user interface system 103 may apply different color visual effects to each of data file icons 440a-d having a different creator (illustrated by the differing shades/patterns). Application of the visual effect (e.g., color) may occur prior or subsequent to the user interface system 103 displaying data file icons 440a-d.

Thus, when the data file icons are displayed, a user may be able to distinguish between different data file properties based on the differing visual effects that may be applied to each data file icon in the displayed collection of data files. Continuing the previous example, a user viewing the embodiment depicted in FIG. 4 may be able to distinguish between the different creators of data files 110a/118a-c simply by noticing the different visual effects (e.g., color) that have been applied by user interface system 103 to each of data file icons 440a-d. For example, data file icon 440a may be associated with data file 110a, which may have been created by UserA. Similarly, UserA may have also created data file 118b which may be associated with data file icon 440c. Because the data files represented by data file icons 440a and 440c in this example were created by the same user (UserA), the same icon visual effect (e.g., the color red) may be applied to each of data file icons 440a and 440c, as depicted in FIG. 4. Continuing the example, data file icon 440b may be associated with data file 118a, which may have been created by UserB; and data file icon 440d may be associated with data file 118c, which may have been created by UserC. To distinguish between the different file creators in this example, user interface 103 applies different icon visual effects to data file icons 440b and 440d (e.g., the colors blue and green, respectively).

Thus, the relationships between data files, data file icons, data file properties (i.e., the creator), and the resulting display in the example given and depicted in FIG. 4 may be further understood according to the following table:

| DATA FILE | DATA FILE ICON | CREATOR | COLOR |
|---|---|---|---|
| 110a | 440a | UserA | red |
| 118a | 440b | UserB | blue |
| 118b | 440c | UserA | red |
| 118c | 440d | UserC | green |

According to the embodiment shown in FIG. 4, a user interacting with user interface system 103 may be able to distinguish between different data file creators based on the different colors that may be applied to each data file icon 440a-d for the displayed collection of data files.

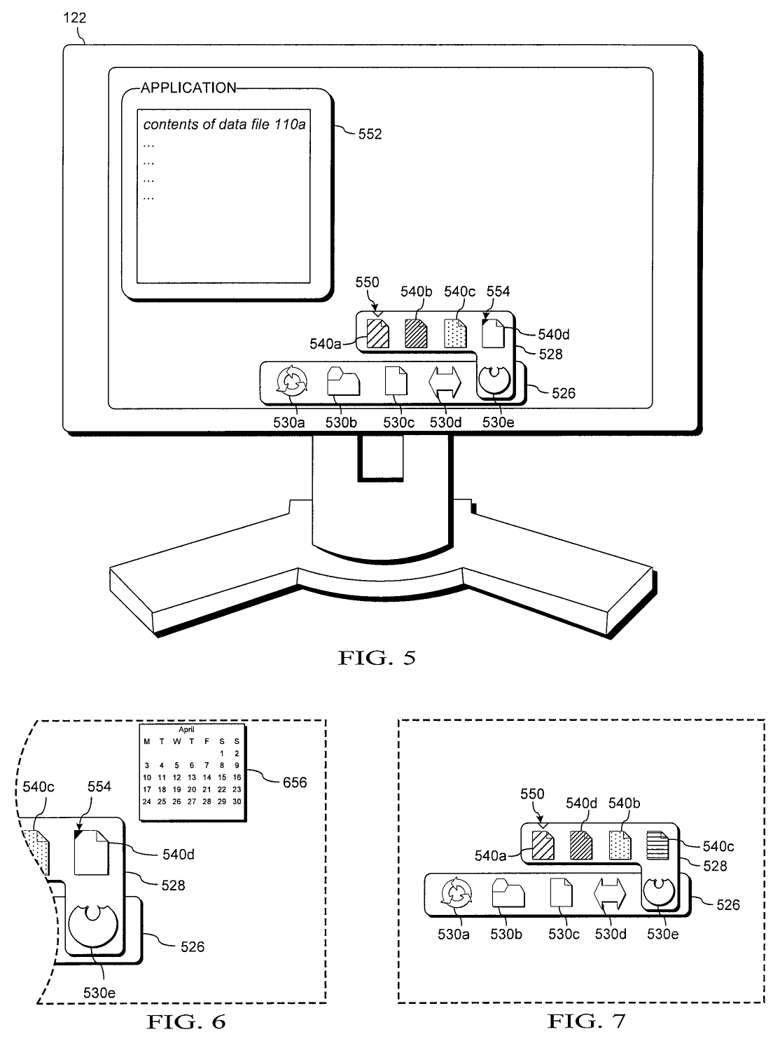

FIG. 5 illustrates a graphical representation of certain embodiments of user interface system 103 displayed on display device 122, in accordance with the present disclosure. As shown in the illustrated embodiment, a menu 526 may be displayed on display device 122, and may include icons 530a-e. Icons 530a-e may each represent a collection of data files (i.e., one or more data files) stored on information handling system 100. As further shown in FIG. 5, a submenu 528 may be displayed on display device 122, and may include data file icons 540a-d. In this embodiment, menu 526 and submenu 528 may be analogous and have similar properties as described with respect to menu 226 and submenu 328 in FIG. 3 with additional properties as described below.

By way of example and with reference to FIG. 5, each data file stored on information handling system 100 may correspond to a data file property representing a due date for the data file; and the following relationships between data files, data file icons, data file properties (i.e., the due date), and the resulting display may exist:

| DATA FILE | DATA FILE ICON | DUE DATE | COLOR |
|---|---|---|---|
| 110a | 540a | March 1 | red |
| 110b | 540b | May 1 | orange |
| 110c | 540c | June 1 | yellow |
| 118a | 540d | none | none |

In operation, software application 552 may have opened or may otherwise be accessing the contents of data file 110a. Where data file icon 540a is associated with data file 110a, user interface system 103 may provide indicator 550 near/on data file icon 540a to indicate that data file 110a is open or otherwise being accessed. User interface system 103 may use any method to determine whether a data file associated with a data file icon is open or otherwise being accessed, such as by polling a list of processes running on information handling system 100 or by querying the storage resource and/or file system on which the data file is stored. Although indicator 550 is illustrated as a triangular shape adjacent to data file icon 540a, indicator 550 may be any type of indicator including different shapes, an alternative data file icon 540a, etc. In addition, indicator 550 may be located in any position relative to data file icon 540a.

Continuing with the example, user interface system 103 may access the due date property for data files 110a-c and 118a. User interface system 103 may be configured to access the due date information (i.e., the data file property) whether such property is embedded within the data file itself, stored and/or managed by a software application, or otherwise stored/and or managed. Thus, according to this example, user interface system 103 may establish a collection of data files, and each may have a corresponding due date (including data file 118, where the due date is “none,” i.e., for which no due date has been set).

User interface system 103 may associate a data file icon with each data file in this established collection, and may also establish a plurality of colors to be applied to each of data files 110a-c/118a according to the due date. As shown in FIG. 5, user interface system 103 may display submenu 528 on display device 122 in response to the selection of icon 530e located on menu 526. In addition and continuing the example, user interface system 103 may apply different color visual effects to each of data file icons 540a-d according to the due date (illustrated by the differing shades/patterns). Application of the visual effect (e.g., color) may occur prior or subsequent to the user interface system 103 displaying data file icons 540a-d.

Thus, when the data file icons are displayed, a user may be able to distinguish between different data file properties based on the differing visual effects that may be applied to each data file icon in the displayed collection of data files. Continuing the previous example, a user viewing the embodiment depicted in FIG. 5 may be able to determine that the due date for data file 110a is prior to the due date for data files 110b-c simply by noticing the different visual effects (e.g., color) that have been applied by user interface system 103 to each of data file icons 540a-c. Similarly, a user viewing the embodiment depicted in FIG. 5 may be able to determine that no due date has been set for data file 118a because no visual effect (e.g., color) has been applied by user interface system 103 to data file icon 5540d.

As shown in FIG. 5, user interface system 103 may provide selectable area 554 near/on data file icon 540d whereby a user may alter a data file property corresponding to a data file. Selectable area 554 may be provided when a data file property is not set (i.e., to let the user set the property) and/or where a data file property is already set (i.e., to let the user modify the property). According to the above example illustrated in FIG. 5, user interface system 103 may provide selectable area 554 for data file icon 540d so that a user may set a due date for data file 118a which does not have a due date.

FIG. 6 illustrates a graphical representation of certain embodiments of user interface system 103 displayed on display device 122, in accordance with the present disclosure. FIG. 6 represents a cropped section of the display device 122 from FIG. 5 with the addition of a calendar 656. Calendar 656 may be provided by user interface 103 (i.e., user interface 103 manages a database of due dates corresponding to data files and provides the calendar graphic that lets users alter the due date property for a given data file), and/or by an external application (e.g., a program management application) communicatively coupled to user interface 103 (e.g., via a software interface).

In operation, user interface 103 may display calendar 656 in response to a user selecting selectable area 554. In this way, a user may set the due date property corresponding to data file 118a. For embodiments in which other properties besides a due date may be set/modified, user interface 103 may display something other than a calendar graphic, such as a text input area, a selectable list, etc. In the embodiment shown in FIG. 6, a user may click a date on calendar 656 to set the due date for data file 118a. To continue with the above example, a user may click April 1 as the due date for data file 118a, resulting in the following relationships (also by way of example and not as a limitation):

| DATA FILE | DATA FILE ICON | DUE DATE | COLOR |
|---|---|---|---|
| 110a | 540a | March 1 | red |
| 110b | 540b | May 1 | yellow |
| 110c | 540c | June 1 | green |
| 118a | 540d | April 1 | orange |

FIG. 7 illustrates a graphical representation of certain embodiments of user interface system 103 displayed on display device 122, in accordance with the present disclosure. FIG. 7 represents a cropped section of the display device 122 from FIG. 5 subsequent to a user's setting of the due date for data file 118a (FIG. 6), according to the previous example.

In operation, user interface 103 may hide calendar graphic 656 (FIG. 6) once a user has set a due date for a data file. Similarly, user interface system 103 may hide selectable area 554 (FIGS. 5-6) once a user has set a property (e.g., a due date) for a data file. In the embodiment shown in FIG. 7, user interface 103 may re-order the graphical display of data file icons 540a-d and similarly may alter the icon visual effect that is applied to each of data file icons 540a-d when the data file property corresponding to one or more files is set/modified.

Thus, when comparing FIGS. 5 and 7, user interface system 103 may, in FIG. 7, display data file icon 540d immediately to the right of data file icon 540a because of the relative due dates of the associated data files. Similarly, user interface system 103 may, in FIG. 7, apply an orange color icon visual effect to data file icon 540d and change the icon visual effect for data file icons 540b-c (i.e., orange to yellow, and yellow to green, respectively). In the same or alternative embodiments, user interface system 103 may not re-order the graphical display of data file icons 540a-d. In the same or still other embodiments, user interface system 103 may not change the applied icon visual effect of data file icons in response to a user setting/modifying a data file property. Nevertheless and according to the embodiment illustrated in FIGS. 5-7, a user may be able to distinguish between the relative importance of a data file (i.e., the order in which the data files are due) based on the differing visual effects (e.g., colors) that may be applied to each data file icon in the displayed collection of data files.

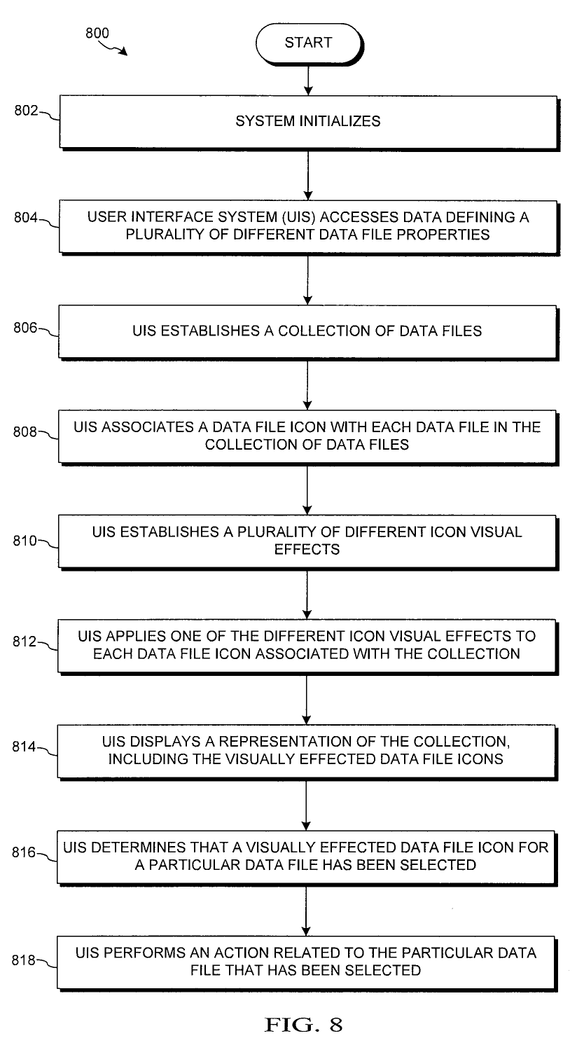

FIG. 8 illustrates a flow chart of an example method 800 for displaying data files in an information handling system including a display device and a user interface system, in accordance with the present disclosure.

According to one embodiment, method 800 preferably begins at step 802. As noted above, teachings of the present disclosure may be implemented in a variety of configurations of information handling system 100. As such, the preferred initialization point for method 800 and the order of the steps 802-818 comprising method 800 may depend on the implementation chosen.

At step 802, information handling system 100 may initialize. For example, information handling system 100 may be powered on, and user interface system 103 may initiate. At step 804, user interface system 103, now running on information handling system 100, may access data defining a plurality of different data file properties. For example, user interface 103 may access any of the following data file properties: a version number corresponding to data files 110a-c/118a-c; the name of a user who created each of data files 110a-c/118a-c; a due date associated with each of data files 110a-c/118a-c; or a date on which each of data files 110a-c/118a-c was last modified.

At step 806, user interface system 103 may establish a collection of data files, where each data file in the collection may correspond to at least one of the data file properties accessed at step 804. For example, user interface system 103 may establish a collection of data files corresponding to three distinct versions of a particular data file. In this example, data files 110a-c may correspond to versions 1, 2, and 3 of the same data file. In the same or alternative embodiments, user interface system 103 may establish a collection of data files corresponding to all data files stored in a particular folder on information handling system 100. In this example, data files 118a-c may all be stored in the same folder and each may correspond to a data file property representing the user who created data files 118a-c. In the same or alternative embodiments, user interface system 103 may establish a collection of data files corresponding to all data files associated with a particular software application. In this example, data files 110a-b and 118c may all be ASCII text files associated with a text editor software application. In the same or alternative embodiments, user interface system 103 may establish a collection of data files corresponding to the most recently accessed data files stored on information handling system 100. In this example, data files 110c and 118a-b may have been accessed (e.g., viewed, modified, created by a user of information handling system 100) more recently than files 110a-b and 118c.

At step 808, user interface system 103 may associate a data file icon with each data file in the collection of data files established in step 806. In some embodiments, user interface system 103 associates the same data file icon with each data file in the collection. In other embodiments, user interface system 103 associates any number of same or different data file icons with the various data files in the collection of data files.

At step 810, user interface system 103 may establish a plurality of different icon visual effects wherein each corresponds to one of the data file properties accessed in step 804. For example, user interface system 103 may establish a plurality of different transparency settings for data file icons. In the same or alternative embodiments, user interface system 103 may establish a plurality of different colors for data file icons.

At step 812, for each data file in the collection of data files established in step 806, user interface system 103 may apply one of the established plurality of different icon visual effects to the data file icon associated with that data file such that the applied icon visual effect represents the data file property corresponding to that data file.

At step 814, user interface system 103 may display, on display device 122, a representation of the collection of data files established in step 806, including displaying the visually effected data file icon (i.e., the visual effect applied in step 812) for each data file in the collection.

At step 816, user interface system 103 may determine that the visually effected data file icon for a particular file has been selected, and at step 818, in response to such a determination, the user interface system 103 may perform an action related to the particular data file that has been selected. For example, user interface system 103 may cause the selected data file to be opened in an associated software application.

Although FIG. 8 discloses a particular number of steps to be taken with respect to method 800, method 800 may be executed with greater or fewer steps than those depicted in FIG. 8. For example, steps 816 and 818 may be omitted. In addition, although FIG. 8 discloses a certain order of steps to be taken with respect to method 800, the steps comprising method 800 may be completed in any suitable order. For example, in the embodiment of method 800 shown above, the user interface system 103 establishing a plurality of different icon visual effects is depicted in step 810. In an alternative embodiment of method 800, user interface system 103 may perform this step between steps 804 and 806.

Method 800 may be implemented using information handling system 100 or any other system operable to implement method 800. In certain embodiments, method 800 may be implemented partially or fully in software embodied in computer-readable media.

Using the methods and systems disclosed herein, problems associated with conventional approaches to displaying data file properties within a user interface system in an information handling system may be improved, reduced, or eliminated.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a display device; and
a user interface system displayed on the display device and configured to:
access data defining a plurality of different data file properties;
establish a collection of data files, each data file corresponding to one of the data file properties;
associate a data file icon with each data file in the collection;
establish a plurality of different icon visual effects, each different icon visual effect corresponding to one of the data file properties;
for each data file in the collection, apply one of the icon visual effects to the data file icon associated with that data file such that the applied icon visual effect represents the data file property corresponding to that data file; and
display a representation of the collection, including displaying the visually effected data file icon for each data file in the collection.

2. An information handling system according to claim 1, the user interface system further configured to:
determine whether the visually effected data file icon for a particular data file has been selected; and
in response to determining that the visually effected data file icon for the particular data file has been selected, perform an action related to the particular data file.

3. An information handling system according to claim 2, wherein the user interface system is configured to open the particular data file with an associated software application in response to determining that the visually effected data file icon for the particular data file has been selected.

4. An information handling system according to claim 1, wherein the plurality of icon visual effects comprises one of: (a) a plurality of different transparency settings for data file icons and (b) a plurality of different colors for data file icons.

5. An information handling system according to claim 1, wherein the same data file icon is associated with each data file in the collection.

6. An information handling system according to claim 1, wherein the plurality of data file properties comprises one of: (a) a plurality of dates on which each data file was last modified, (b) a plurality of names corresponding to a user who created each data file, (c) a plurality of due date associated with each data file, and (d) a plurality of version numbers corresponding to a particular data file.

7. An information handling system according to claim 1, wherein the collection of data files is established according to at least one of the following criteria: (a) all data files stored in a particular folder on the information handling system, (b) the most recently accessed data files, (c) all versions of a particular data file, and (d) all data files associated with a particular software application.

8. A method for displaying data file properties in an information handling system including a display device and a user interface system, the method comprising:
the user interface system accessing data defining a plurality of different data file properties;
the user interface system establishing a collection of data files, each data file corresponding to one of the data file properties;
the user interface system associating a data file icon with each data file in the collection;
the user interface system establishing a plurality of different icon visual effects, each different icon visual effect corresponding to one of the data file properties;
for each data file in the collection, the user interface system applying one of the icon visual effects to the data file icon associated with that data file such that the applied icon visual effect represents the data file property corresponding to that data file; and
the user interface system displaying on the display device a representation of the collection, including displaying the visually effected data file icon for each data file in the collection.

9. A method according to claim 8, further comprising:
the user interface system determining whether the visually effected data file icon for a particular data file has been selected; and
in response to determining that the visually effected data file icon for the particular data file has been selected, the user interface system performing an action related to the particular data file.

10. A method according to claim 9, wherein the particular data file is opened with an associated software application in response to determining that the visually effected data file icon for the particular data file has been selected.

11. A method according to claim 8, wherein the plurality of icon visual effects comprises one of: (a) a plurality of different transparency settings for data file icons and (b) a plurality of different colors for data file icons.

12. A method according to claim 8, wherein the same data file icon is associated with each data file in the collection.

13. A method according to claim 8, wherein the plurality of data file properties comprises one of: (a) a plurality of dates on which each data file was last modified, (b) a plurality of names corresponding to a user who created each data file, (c) a plurality of due date associated with each data file, and (d) a plurality of version numbers corresponding to a particular data file.

14. A method according to claim 8, wherein the collection of data files is established according to at least one of the following criteria: (a) all data files stored in a particular folder on the information handling system, (b) the most recently accessed data files, (c) all versions of a particular data file, and (d) all data files associated with a particular software application.

15. A user interface system for an information handling system, the user interface system configured to:
access data defining a plurality of different data file properties;
establish a collection of data files, each data file corresponding to one of the data file properties;
associate a data file icon with each data file in the collection;
establish a plurality of different icon visual effects, each different icon visual effect corresponding to one of the data file properties;
for each data file in the collection, apply one of the icon visual effects to the data file icon associated with that data file such that the applied icon visual effect represents the data file property corresponding to that data file; and
display, on a display device, a representation of the collection, including displaying the visually effected data file icon for each data file in the collection.

16. A user interface system according to claim 15, further configured to:
determine whether the visually effected data file icon for a particular data file has been selected; and
in response to determining that the visually effected data file icon for the particular data file has been selected, perform an action related to the particular data file.

17. A user interface system according to claim 15, wherein the plurality of icon visual effects comprises one of: (a) a plurality of different transparency settings for data file icons and (b) a plurality of different colors for data file icons.

18. A user interface system according to claim 15, wherein the same data file icon is associated with each data file in the collection.

19. A user interface system according to claim 15, wherein the plurality of data file properties comprises one of: (a) a plurality of dates on which each data file was last modified, (b) a plurality of names corresponding to a user who created each data file, (c) a plurality of due date associated with each data file, and (d) a plurality of version numbers corresponding to a particular data file.

20. A user interface system according to claim 15, wherein the collection of data files is established according to at least one of the following criteria: (a) all data files stored in a particular folder on the information handling system, (b) the most recently accessed data files, (c) all versions of a particular data file, and (d) all data files associated with a particular software application.
